(19) United States
(12) Patent Application Publication
(10) Pub. No.: US 2006/0118326 A1
(43) Pub. Date: Jun. 8, 2006

(54) Removal position-indicating adhesive tape

(75) Inventors: Masato Koike, Susono-shi (JP); Susumu Hara, Susono-shi (JP); Atsushi Sugiyama, Susono-shi (JP); Hiroshi Ichikawa, Susono-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/290,419

(22) Filed: Dec. 1, 2005

(30) Foreign Application Priority Data
Dec. 1, 2004 (JP) P2004-348387

(51) Int. Cl. H01B 3/00

(52) U.S. Cl. 174/137 B

(57) ABSTRACT

A removal position-indicating adhesive tape is adapted to be stuck on a removal position portion of a wire harness before the wire harness is installed in a vehicle in order to indicate the removal position portion of the wire harness with which a removal jig is brought into engagement when removing the wire harness from the vehicle to be scrapped. The adhesive tape includes a substrate made of a polyolefin resin or a polyvinyl chloride resin, an adhesive layer formed on one side of the substrate, a printing surface which is provided at the other side of the substrate, and has a predetermined mark and/or a predetermined letter printed thereon, and a transparent or translucent protective film which is made of a polyolefin resin or a polyvinyl chloride resin, and is laminated on the substrate to cover the printing surface.

### BACKGROUND OF THE INVENTION

1. Field of the Invention

This invention relates to an adhesive tape for being stuck on a removal position portion of a wire harness before it is installed in a vehicle in order to indicate the removal position portion of the wire harness with which a removal jig is brought into engagement when removing the wire harness from the vehicle to be scrapped.

2. Related Art

In recent years, environmental problems have drawn increasing attention, and products to be scrapped or discarded have now been classified according to the kind of constituent material, and have been disposed of, and in some cases, the classified materials have been reused. For example, in the case of scrapping an automobile, there has been used a method in which wire harnesses, installed in the automobile, are removed from the automobile in a classified manner, and are disposed of. In many cases, such a wire harness is installed or received in a narrow space in a roof panel, a door panel or the like, and in order to efficiently effect this removing operation, there has been used a method in which connectors of the wire harness are withdrawn or disconnected from associated equipments, and then the roof panel or the like is opened so as to expose a portion of the wire harness, and then a hook of a crane is engaged with a suitable section of the exposed portion of the wire harmless, and then the hook is pulled, thereby withdrawn the wire harness at a time.

In this case, when the hook is engaged with an improper portion of the wire harness, the hook slides laterally along the wire harness, or the wire harness is broken or cut off intermediate opposite ends thereof, so that the wire harness can not be removed successfully, and besides there is a fear that the worker gets injured. Thus, there have been encountered problems with the efficiency of the removing operation and the operation safety.

Therefore, in order that the operation for removing a wire harness can be effected safely, smoothly and efficiently, there has been proposed a method in which a wire harness maker sticks a removal position-indicating adhesive tape (having a pattern or mark of a hook, a letter or the like printed thereon) on a suitable portion of each wire harness (produced by this wire harness maker) with which a hook is to be engaged, and supplies such wire harnesses to an automobile manufacturer, and the automobile manufacturer installs the wire harnesses (each having the removal position-indicating adhesive tape stuck thereon) in automobiles (see, for example, JP-A-2003-217357).

Wire harnesses, once installed in an automobile, will not be exchanged, and therefore will be kept received in the automobile until the automobile is scrapped. Today, automobiles have enhanced durability, and there are not a few automobiles which are used for nearly 10 years unless they are involved in a large accident.

On the other hand, a conventional removal position-indicating adhesive tape is similar in construction to an ordinary adhesive tape with a pattern for packing purposes. As schematically shown in FIG. 2, the conventional removal position-indicating adhesive tape has an adhesive layer 5 formed on one side (or surface) of a substrate 6, and a mark such for example of a picture of a hook (not shown) is printed on the other side (printing surface) 4 of the substrate 6. A cellulose film is used as the substrate 6 as is the case with the packing-purpose adhesive tape with the pattern.

However, the cellulose film does not have sufficient thermal resistance, chemical resistance and so on, and therefore is gradually deteriorated by radiating heat (developing during the driving of a car) and upon contact with a washing liquid, a battery liquid, various oils and so on. As a result, there is a possibility that the removal position-indicating adhesive tape is separated from the wire harness, or fails to retain its shape, so that it becomes impossible to recognize the proper portion of the wire harness with which the hook is to be engaged when scrapping the car.

And besides, the wire harness is installed or received in a narrow space in a roof panel, a door panel or the like, and therefore is subjected to vibrations during the driving of the car, and is often brought into contact with a neighboring panel surface or other. The removal position-indicating adhesive tape has the exposed printing surface 4, and therefore the printing surface 4 can be worn upon contact with the panel surface or other, so that the mark or pattern thereon is erased.

This invention has been made in view of the above circumstances, and an object of the invention is to provide a removal position-indicating adhesive tape which is capable of satisfactorily maintaining a removal position-indicating function for a long period of time.

### SUMMARY OF THE INVENTION

The above object has been achieved by a removal position-indicating adhesive tape of the present invention recited in the following.

(1) A removal position-indicating adhesive tape for being stuck on a removal position portion of a wire harness before the wire harness is installed in a vehicle in order to indicate the removal position portion of the wire harness with which a removal jig is brought into engagement when removing the wire harness from the vehicle to be scrapped; characterized in that:

the adhesive tape comprises a substrate made of a polyolefin resin or a polyvinyl chloride resin, an adhesive layer formed on one side of the substrate, a printing surface which is provided at the other side of the substrate, and has a predetermined mark and/or a predetermined letter printed thereon, and a transparent or translucent protective film which is made of a polyolefin resin or a polyvinyl chloride resin, and is laminated on the substrate to cover the printing surface.

(2) Each of the substrate and the protective film may be made of the polyolefin resin.

(3) Each of the substrate and the protective film may be made of a polypropylene resin.

The removal position-indicating adhesive tape of the invention comprises the substrate made of the polyolefin resin or the polyvinyl chloride resin, and therefore is more excellent in thermal resistance, chemical resistance and durability than the conventional removal position-indicating tape comprising the substrate formed of a cellulose film. And besides, the mark, the letter or the like, printed on the printing surface, is protected by the protective film made of the polyolefin resin or the polyvinyl chloride resin, and therefore the mark, the letter or the like will not be erased upon contact with a panel surface or other.

### BRIEF DESCRIPTION OF THE DRAWINGS

FIG. 1 is a schematic view showing the structure of a removal position-indicating adhesive tape of the present invention.

FIG. 2 is a schematic view showing the structure of a conventional removal-position indicating adhesive tape.

### DETAILED DESCRIPTION OF THE PREFERRED EMBODIMENTS

The present invention will now be described in detail with reference to the drawings.

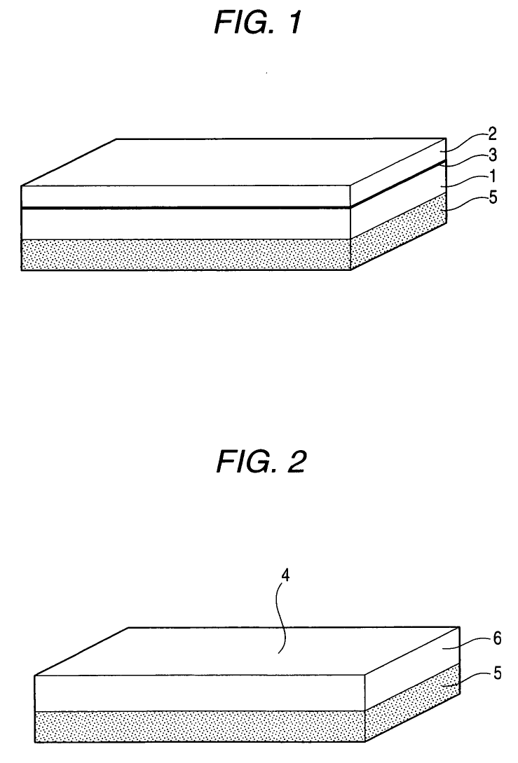

FIG. 1 is a schematic view showing the structure of a removal position-indicating adhesive tape of the invention. An adhesive layer 5 is formed on one side (or surface) of a substrate 1, and a printing surface 3, having a predetermined mark or a predetermined letter (for example, a picture or pattern of a hook (not shown)) printed thereon, is provided at the other side of the substrate 1. Further, a protective film 2 is laminated on the substrate 1 to protect the printing surface 3.

A film which is made of a polyolefin resin or a polyvinyl chloride resin, and has a suitable thickness (for example, 50 μm to 100 μm) is cut into a suitable width to provide the substrate 1. The polyolefin resin and the polyvinyl chloride resin are more excellent in thermal resistance and chemical resistance than cellulose used as a conventional substrate material, and therefore even when this film, together with a wire harness, is kept received in an automobile for a long period of time, the film is less liable to be deteriorated even upon contact with a washing liquid, a battery liquid, various oils and soon. In some cases, the removal position-indicating adhesive tape is discarded and burned or incinerated after the removal of the wire harness is finished. The polyvinyl chloride resin, when burned, produces chlorine gas having corrosive properties, and therefore in view of waste disposal by incineration, it is preferred that a polyolefin resin be used as the substrate material. Among polyolefin resins, the use of a polypropylene resin is preferred since it has an excellent tensile strength.

Any suitable adhesive can be used to form the adhesive layer 5 in so far as it can adhere to a polyolefin resin or a vinyl chloride resin, and suitable examples include a butyl adhesive, acrylic adhesive, a silicone rubber adhesive, a vinyl ether adhesive, a natural rubber adhesive and a styrene-butadiene rubber adhesive. Although the adhesive layer 5 can be set to a suitable thickness according to the need, this thickness is usually 15 μm to 40 μm. A suitable primer coat can be formed on the substrate, in which case the adhesive is coated on this primary coat.

Printing ink for forming the printing surface 3 can be suitably selected from known types used for printing on a polyolefin resin and a polyvinyl chloride resin. For example, the use of acrylic ink and polyurethane ink is preferred. A polyolefin resin has low printing properties (low ink adhesion), and therefore is usually subjected to a surface treatment such as the coating of a primer, a sandblasting treatment, a chromium mixed acid treatment, a flame treatment, a corona discharge treatment and a plasma treatment. In the present invention, however, the protective film 2 is laminated on the substrate 1, and therefore such surface treatment is not always necessary, and the invention is advantageous from the viewpoint of a production cost.

Like the substrate 1, the protective film 2 is made of a polyolefin resin or a polyvinyl chloride resin. The substrate 1 and the protective film 2 can be made of the same resin, or can be made of different resins, respectively. However, preferably, the protective film 2 is made of a polyolefin resin (particularly, a polypropylene resin) as described above for the substrate 1, and most preferably, both of the substrate 1 and the protective film 2 are made of a polypropylene resin.

The film, made of a polyolefin resin or a polyvinyl chloride resin, is opaque, and when the film is too thick, its visibility for the printing surface 3 is poor. Therefore, in the invention, preferably, the thickness of the protective film 2 is slightly smaller than the thickness of the substrate 1, and more specifically is in the range of from 25 μm to 50 μm.

For laminating the protective film 2 on the substrate 1, an adhesive is used. Any suitable adhesive can be used in so far as it can adhere to a polyolefin resin or a vinyl chloride resin as is the case with the adhesive used to form the adhesive layer 5, and suitable examples include a butyl adhesive, acrylic adhesive, a silicone rubber adhesive, a vinyl ether adhesive, a natural rubber adhesive and a styrene-butadiene rubber adhesive. Although this adhesive can be set to a suitable thickness according to the need, it is appropriate that the thickness be usually 5 μm to 10 μm.

In the above adhesive tape, the printing surface 3 can be formed on that side (or surface) of the substrate 1 facing away from the adhesive layer 5, or can be formed on that side (or surface) of the protective film facing the substrate 1. However, it is preferred from the viewpoint of visibility that the mark be printed on the protective film 2 since the adhesive is interposed between the substrate 1 and the protective film 2.

### EXAMPLES

Although the invention will be further described below by way of Example and Comparative Example, the invention is not limited to the following Example.

### Example 1

A polypropylene resin-made film with a thickness of 70 μm was cut to prepare a substrate having a length of about 5 cm and a width of 19 mm. A polypropylene resin-made film with a thickness of 50 μm was cut into the same size and shape as those of the substrate to prepare a protective film. Then, a pattern or mark of a hook was printed on one side (or surface) of the protective film, using acrylic ink, and a polyester adhesive was coated on the printing, surface of the protective film, and the protective film was bonded to the substrate by heat and pressure. Thereafter, an acrylic adhesive was coated on that side (or surface) of the substrate, facing away from the protective film, to form an adhesive layer, thereby preparing a test piece.

Thermal resistance and battery liquid resistance of the thus obtained test piece were evaluated in the following manner.

[Evaluation of Thermal Resistance]

The test piece was bonded to a Mylar film, and was left in a Geer oven maintained at a temperature of 120° C. After the test piece was left in the oven for 313 hours, the test piece was taken out of the oven, and was observed with the eyes so as to determine whether or not any change in color of the printed portion has occurred. Observation results are shown in Table 1 in which “O” represents a condition in which any color change did not occur in the printed portion, while “X” represents a condition in which a color change occurred in the printed portion. The condition of the printed portion in the ordinary state (before heating) is also shown in Table 1.

[Evaluation of Battery Liquid Resistance]

The test piece was bonded to a Mylar film, and was immersed in a battery liquid for 2 hours at a temperature of 25° C., and then was taken out of an immersion bath, and was allowed to stand for 24 hours in an atmosphere of an ordinary temperature, and then the test piece was observed with the eyes so as to determine whether or not the test piece was dissolved. Observation results are shown in Table 1 in which “Good” represents a condition in which no dissolution occurred, while “Bad” represents a condition in which dissolution occurred. The condition of the test piece in the ordinary state (before immersion) is also shown in Table 1.

A pattern or mark of a hook was printed on one side (or surface) of a cellulose substrate having a length of about 5 cm, a width of 19 mm and a thickness of 70 μM as in Example 1, and an acrylic adhesive was coated on the other side of the substrate to form an adhesive layer, thereby preparing a test piece. Thermal resistance and battery liquid resistance of the thus obtained test piece were evaluated according to the same procedure as described in Example 1. Evaluation results are shown in Table 1.

TABLE 1

| | | Example 1 | Comparative Example 1 |
|---|---|---|---|
| Thermal | Ordinary State | ◯ | ◯ |
| Resistance | After heating | ◯ | X |
| Battery Liquid | Ordinary state | Good | Good |
| Resistance | After immersion | Good | Bad |
| | in battery liquid | | |

As shown in Table 1, with respect to the test piece of Comparative Example 1 comprising the cellulose substrate having no protective film laminated thereon, the printed portion is not subjected to a color change at the ordinary temperature, but is subjected to a color change in the heated condition, and besides this test piece is attacked by the battery liquid. On the other hand, with respect to the test piece of Example 1 of the invention, the printed portion is not subjected to a color change even when the test piece is heated, and besides this test piece is not attacked by the battery liquid. Thus, the test piece has the excellent thermal resistance and chemical resistance, and the durability thereof is greatly enhanced.

What is claimed is:

1. A removal position-indicating adhesive tape attached at a position in a wire harness in order to indicate a removal position portion of the wire harness with which a removal jig is brought into engagement when removing the wire harness from a vehicle, said adhesive tape comprising:
a substrate made of a polyolefin resin or a polyvinyl chloride resin;
an adhesive layer formed on one side of said substrate; and
a printing surface which is provided at another side of said substrate, on which a predetermined mark and/or letter is printed; and
a transparent or translucent protective film made of a polyolefin resin or a polyvinyl chloride resin, covering said printing surface.

2. A removal position-indicating adhesive tape according to claim 1, wherein each of said substrate and said protective film is made of the polyolefin resin.

3. A removal position-indicating adhesive tape according to claim 2, wherein each of said substrate and said protective film is made of a polypropylene resin.
